(19) United States
(12) Patent Application Publication
(10) Pub. No.: US 2014/0278692 A1
(43) Pub. Date: Sep. 18, 2014

(54) MANAGING A FACILITY

(71) Applicants: Manish Marwah, Palo Alto, CA (US); Alan A. McReynolds, Palo Alto, CA (US); Amip J. Shah, Palo Alto, CA (US); Zhikui Wang, Palo Alto, CA (US); Chandrakant Patel, Palo Alto, CA (US); Daniel Juergen Gmach, Palo Alto, CA (US); Chris D. Hyser, Victor, NY (US); Niru Kumari, Palo Alto, CA (US); Zhenhua Liu, Palo Alto, CA (US); Cullen E. Bash, Los Gatos, CA (US); Martin Arlitt, Calgary (CA); Sergey Blagodurov, Burnaby (CA); Yuan Chen, Palo Alto, CA (US); Thomas W. Christian, Fort Collins, CO (US)

(72) Inventors: Manish Marwah, Palo Alto, CA (US); Alan A. McReynolds, Palo Alto, CA (US); Amip J. Shah, Palo Alto, CA (US); Zhikui Wang, Palo Alto, CA (US); Chandrakant Patel, Palo Alto, CA (US); Daniel Juergen Gmach, Palo Alto, CA (US); Chris D. Hyser, Victor, NY (US); Niru Kumari, Palo Alto, CA (US); Zhenhua Liu, Palo Alto, CA (US); Cullen E. Bash, Los Gatos, CA (US); Martin Arlitt, Calgary (CA); Sergey Blagodurov, Burnaby (CA); Yuan Chen, Palo Alto, CA (US); Thomas W. Christian, Fort Collins, CO (US)

(21) Appl. No.: 14/353,607

(22) PCT Filed: Dec. 23, 2011
(86) PCT No.: PCT/US2011/067127

§ 371 Date: Apr. 23, 2014

(51) Int. Cl. G06Q 10/06

(52) U.S. Cl. CPC G06Q 10/06312
USPC 705/7.22

(57) ABSTRACT

In a method for managing a facility that is to receive resources from a first resource supply, a supply of resources available from the first resource supply is predicted for a predetermined period of time. In addition, a demand for resources in the facility during the predetermined period of time is predicted. A capacity schedule for the facility is planned to meet a predefined operational goal, in which the plan of the capacity schedule uses as inputs, the predicted supply of resources available from the first resource supply and the predicted demand for resources in the facility during the predetermined period of time. Moreover, a determination as to whether the planned capacity schedule meets the predefined operational goal is made.

### BACKGROUND

Various techniques to decrease both the costs and the environmental footprints associated with operating various types of facilities have been and continue to be developed. Some techniques include optimization of energy efficiencies associated with supplying power to the machines and cooling systems in the facilities. Other techniques include metrics for measuring holistic energy efficiency, dynamic thermal management of air-conditioners based on resource demands of the machines, aisle containment, thermally-aware as well as energy-aware virtualized workload placement, and integration of the facility with local (external) ambient conditions through economizers or on-site renewable energy sources such as wind and solar.

### BRIEF DESCRIPTION OF THE DRAWINGS

Features of the present disclosure are illustrated by way of example and not limited in the following figure(s), in which like numerals indicate like elements, in which:

FIG. 1 shows a simplified block diagram of a facility managing system, according to an example of the present disclosure;

FIG. 2 shows a simplified block diagram of a facility manager, according to an example of the present disclosure;

FIG. 3 shows a flow diagram of a method for managing a facility, according to an example of the present disclosure; and

FIG. 4 illustrates a schematic representation of a computing device, which may be employed to perform various functions of the facility manager module depicted in FIG. 2, according to an example of the present disclosure.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, the term “including” means including but not limited to. The term “based on” means based at least in part on. In addition, the terms “a” and “an” are intended to denote at least one of a particular element.

Disclosed herein are a method and a facility manager for managing a facility that is to receive resources from a first resource supply. The facility may also receive resources from a second resource supply, in which the first resource supply differs from the second resource supply. The first resource supply differs from the second resource supply in that at least one of: the first resource supply comprises a renewable power supply and the second resource supply comprises a non-renewable power supply, a resource available from the first resource supply is relatively less expensive than a resource available from the second resource supply, the first resource supply is relatively more sustainable than the second resource supply, etc. In other words, for instance, obtaining resources from the first resource supply may be preferable in terms of at least one of cost, sustainability, etc., as compared with obtaining resources from the second resource supply. In this regard, in certain instances, such as when the price of resources from a non-renewable resource supply is lower than the price of resources from a renewable resource supply, the first resource supply may comprise a non-renewable resource supply and the second resource supply may comprise a renewable resource supply.

In one regard, the method and facility manager disclosed herein enable machines in the facility to perform workloads and dependent system components, such as, cooling system components, to cool the machines, while substantially meeting a predefined operational goal. More particularly, the machines perform the workloads and the cooling system components cool the machines while substantially meeting the operational goal and while factoring the supply of resources available from the first resource supply. In other words, for instance, the facility is to be managed to perform the workloads while at least one of minimizing the total cost of ownership of the facility, operating the facility at least a net-zero non-renewable energy consumption, minimizing grid power usage, maximizing usage of renewable resources, etc.

As described in greater detail herein, supply-side constraints, such as, energy availability, cooling availability, water availability, chemical availability, etc., are considered together with workload constraints (or flexibilities) in planning a capacity schedule in the facility. In one regard, the integration of the supply-side constraints and the workload constraints in planning a capacity schedule may result in significant power and/or environmental footprint reductions. According to an example, the method and facility manager disclosed herein may enable at least a “net-zero energy” facility, which may be designed and managed in a manner that uses renewable resources to entirely offset the use of any non-renewable resources. In other words, a “net-zero energy” facility may be able to pass excess energy back into the grid or to a second resource supply that supplies non-renewable energy and may thus be a negative “net-zero energy” facility. In addition, disclosed herein are manners in which the use of resources supplied by particular resource supplies over resources supplied by other resource supplies along with dynamic workload scheduling and integrated management techniques may be implemented to improve overall facility utilization while allowing workload demand, and in certain instances, cooling demand, to be “shaped” according to resource availability.

In one example, demand for resources by non-critical workloads is “shifted” by scheduling the non-critical workload and allocating resources within the facility according to the availability of resources supplied by the first resource supply and the efficiency of cooling the machines that perform the workloads. The shifting of the non-critical demand is generally a complex optimization problem due to the dynamism in the supply of resources and demand for resources and their interaction. For instance, on one hand, given the lower electricity price and cooling cost of outside air cooling at night, non-critical workloads, such as, batch jobs, non-interactive workloads, delay-tolerant workloads, etc., should be scheduled to be performed at night. On the other hand, if the renewable resource comprises power available from solar panels, the renewable resource will only be available during the day. As such, when using renewable resources, it may be beneficial to perform the non-critical workloads during the day to reduce recurring power cost and environmental impact.

With reference first to FIG. 1, there is shown a block diagram of a facility managing system 100, according to an example. It should be understood that the facility managing system 100 may include additional components and that one or more of the components described herein may be removed and/or modified without departing from a scope of the facility managing system 100.

The facility managing system 100 includes a facility 102, a first resource supply 120, and a second resource supply 130. Although not shown, the facility management system 100 may include additional resources supplies that share a similar characteristic to one of the first resource supply 120 and the second resource supply 130. In this regard, the resource supplies may form a microgrid of resource supplies to supply resources to the facility 102. According an example, the facility managing system 100 includes a plurality of first resource supplies 120, in which the first resource supplies 120 comprise different types of renewable resource supplies. For instance, one of the first resource supplies 120 may comprise a solar panel and another one of the first resource supplies 120 may comprise a biogas resource supply. In addition, for instance, because the biogas resource supply is likely to be able to provide a more consistent amount of resources, the biogas resource supply may provide a base amount of resources and the resources from the solar panel may be used to provide variable resources to the facility 102 as those resources are available. Moreover, in this example, the second resource supply 130, which may comprise a non-renewable resource supply, may supply resources to the facility 102 as a backup to the first resource supply 120.

The facility 102 is depicted as including a resource supply monitor 104, a resource demand monitor 106, a facility manager 108, a resource demand controller 110, resource demand machines 112, a dependent system controller 114, and dependent system components 116. The facility 102 comprises any suitable type of facility that is to receive resources from both the first resource supply 120 and the second resource supply 130 and is to be cooled by a cooling system. By way of example, the facility 102 comprises a data center, an office or academic building, an industrial manufacturing facility, a chemical processing facility, a clean-room, an automobile manufacturing facility, etc. In this example, the resource demand machines 112 may comprise computers, servers, networking devices, data storage devices, robotic devices, lifting machines, air purifiers, or other apparatuses that consume energy and generate heat while operational. In addition, the dependent system components 116 may comprise components that support resource demand machines 112.

By way of example, the dependent system components 116 may comprise air-conditioning units, air handlers, blowers, chillers, adaptive vent tiles, or other apparatuses that vary the provisioning of cooling resources supplied into the facility 102 and to the resource demand machines 112. The cooling resources may comprise airflow, chilled water flow, etc., and may be supplied by the dependent system components 116, which consume energy, and/or from the environment, such as cool airflow or water flow, which may also considered as a first (renewable) resource supply 120 in the present disclosure. As other examples, the dependent system components 116 may comprise other types of components that consume resources, such as, air purification devices, heaters, fluid pumps, etc.

The resource demand controller 110 comprises a device and/or sets of machine readable instructions stored in a memory to control the performance of workloads on the resource demand machines 112. For instance, the resource demand controller 110 is to control placement of workloads on the resource demand machines 112 based upon a capacity schedule as planned by the facility manager 108. The dependent system controller 114 comprises a device and/or sets of machine readable instructions stored in a memory to control the provisioning of cooling resources supplied by the dependent system components 116. According to an example, the dependent system controller 114 receives instructions from the facility manager 108 and controls the dependent system components 116 according to the received instructions. In other examples, the dependent system controller 114 operates independently of the facility manager 108.

As discussed above, the first resource supply 120 differs from the second resource supply 130, in that, for instance, it may be preferable to receive resources from the first resource supply 120 as compared with the second resource supply 130. By way of example, the first resource supply 120 may comprise a renewable power supply and the second power supply 130 may comprise a non-renewable power supply. The first resource supply 120 may thus comprise at least one of a photovoltaic energy source, a wind energy source, a hydroelectric energy source, a biogas energy source, a cooling resource supply, etc. The second resource supply 130 may comprise at least one of a utility electrical power grid, a diesel powered energy source, on-site stored energy source, etc. The on-site stored energy source may be electrochemical (for instance, batteries), thermal (for instance, ice), mechanical (for instance, flywheel), etc.

In another example, a resource available from the first resource supply 120 may be relatively less expensive to obtain than a resource available from the second resource supply 130. As a further example, the first resource supply 120 may be relatively more sustainable than the second resource supply 130. In this example, the first resource supply 120 may have a relatively smaller carbon footprint, for instance, as compared with the second resource supply 130.

At various times, the facility 102 may receive resources from the first resource supply 120, the second resource supply 130, or both the first resource supply 120 and the second resource supply 130. Although resources from the first resource supply 120 are in general preferable than resources from the second resource supply 130, the supply of resources from the first resource supply 120 may often be unsteady. For instance, resources available from a renewable resource supply often varies with time, local weather conditions, locations of local power generators, etc. As such, it is often impossible or impractical for facilities to rely solely on resources available from the first resource supply 120. In one regard, therefore, disclosed herein are a method and a facility manager 108 for maximizing the use of resources available from the first resource supply 120 while still meeting workload performance requirements, which may be outlined in service level agreements. In another regard, the method and facility manager 108 disclosed herein may significantly reduce non-renewable resource consumption and environmental impact of operating a facility 102.

The resource supply monitor 104 comprises any suitable device and/or set of machine readable instructions that tracks the supply of resources from the first resource supply 120 and the second resource supply 130. In one example, the resource supply monitor 104 is positioned in line with the respective supplies of resources from the first resource supply 120 and the second resource supply 130. In another example, the resource supply monitor 104 receives data from the first resource supply 120 and the second resource supply 130 pertaining to the supply of resources from the first resource supply 120 and the second resource supply 130. According to an example, the resource supply monitor 104 also receives prices for the resources available from the second resource supply 130 for various periods of time.

The resource demand monitor 106 comprises any suitable device and/or set of machine-readable instructions stored in a memory that tracks the demands for resources by the resource demand machines 112. In one example, the resource demand monitor 106 directly tracks the resource demand on the resource demand machines 112. In another example, data pertaining to the resource demands of the resource demand machines 112 is supplied to the resource demand monitor 106 from other sources, such as, from historical resource demand traces.

According to a particular example, the facility 102 comprises a data center. In this example, the resource demand machines 112 comprise a plurality of servers to perform various critical and non-critical information technology (IT) workloads. In addition, the dependent system components 116 comprise air delivery apparatuses positioned in the data center to supply airflow to the resource demand machines 112. In one example, the resource demand machines 112 are arranged on electronics racks and the dependent system components 116 supply cooling airflow and/or cooling liquid to the resource demand machines 112.

Turning now to FIG. 2, there is shown a block diagram of a facility manager 200 according to an example. According to an example, the facility manager 200 comprises the facility manager 108 depicted in FIG. 1. In any regard, the facility manager 200 may comprise a server, a computer, a laptop computer, a tablet computer, a personal digital assistant, a cellular telephone, or other electronic apparatus.

The facility manager 200 is depicted as including a facility manager module 202, a data store 220, and a processor 230. The facility manager module 202 is depicted as including an input/output module 204, a resource supply prediction module 206, a resource demand prediction module 208, a capacity schedule planning module 210, a capacity schedule execution module 212, a monitoring module 214, and an operational goal determination module 216. The processor 230, which may comprise a microprocessor, a micro-controller, an application specific integrated circuit (ASIC), and the like, is to perform various processing functions in the facility manager 200. One of the processing functions includes invoking or implementing the modules 204-216 of the facility manager module 202 as discussed in greater detail herein below.

According to an example, the facility manager module 202 comprises a hardware device, such as, a circuit or multiple circuits arranged on a board. In this example, the modules 204-216 comprise circuit components or individual circuits. According to another example, the facility manager module 202 comprises a volatile or non-volatile memory, such as dynamic random access memory (DRAM), electrically erasable programmable read-only memory (EEPROM), magnetoresistive random access memory (MRAM), Memristor, flash memory, floppy disk, a compact disc read only memory (CD-ROM), a digital video disc read only memory (DVD-ROM), or other optical or magnetic media, and the like. In this example, the modules 204-216 comprise software modules stored in the facility manager module 202. According to a further example, the modules 204-216 comprise a combination of hardware and software modules.

Although not explicitly depicted in FIG. 2, the facility manager 200 may include various interfaces for communicating with the resource supply monitor 104, the resource demand monitor 106, the resource demand controller 110, and the dependent system controller 114. The facility manager 200 may also include various interfaces (not shown) to enable receipt of instructions and to output of various data. The various interfaces may comprise hardware and/or software interfaces. In any regard, the various interfaces may be connected to a network over which the facility manager 200 may receive the various data.

The processor 230 may store data received through the various interfaces in the data store 220 and may use the data in implementing the modules 204-216. The data store 220 comprises volatile and/or non-volatile memory, such as DRAM, EEPROM, MRAM, phase change RAM (PCRAM), Memristor, flash memory, and the like. In addition, or alternatively, the data store 220 comprises a device that is to read from and write to a removable media, such as, a floppy disk, a CD-ROM, a DVD-ROM, or other optical or magnetic media.

Various manners in which the modules 204-216 of the facility manager module 202 may be implemented are discussed in greater detail with respect to the method 300 depicted in FIG. 3. FIG. 3, more particularly, depicts a flow diagram of a method 300 for managing a facility 102, according to an example. It should be apparent to those of ordinary skill in the art that the method 300 represents a generalized illustration and that other steps may be added or existing steps may be removed, modified or rearranged without departing from a scope of the method 300. Although particular reference is made to the facility manager module 202 depicted in FIG. 2 as comprising an apparatus and/or a set of machine readable instructions that may perform the operations described in the method 300 may be performed, it should be understood that differently configured apparatuses and/or machine readable instructions may perform the method 300 without departing from a scope of the method 300.

At block 302, a supply of resources available from a first resource supply 120 for a predetermined period of time is predicted, for instance, by the resource supply prediction module 206. The predetermined period of time comprises any suitable period of time in the future that includes, for instance, a few minutes, an hour or more, a day, a week, a month, a year, etc. Thus, for instance, the supply prediction module 206 may predict the level of resources, such as, electricity, water, cool air, chemicals, etc., that will likely be available over the predetermined period of time. The supply prediction module 206 may use historical data, for instance, as collected by the resource supply monitor 104, a description of the first resource supply 120, weather information, etc., to predict the supply of resources available from the first resource supply 120 for the predetermined period of time. The description of the first resource supply 120 may include, for instance, characteristics of components of the first resource supply 120, such as, photovoltaic panels, wind turbines, etc. The weather information may include historical weather data, current weather conditions, forecasts of future weather conditions, such as, temperature, cloudiness, wind speed, solar angle, etc.

According to an example, the prediction for the resources available from the first resource supply 120 for the predetermined period of time is made by using the k-nearest neighbor technique. In this technique, a local search for the most “similar” days in the past is performed and a weighted average of those days is used to make a prediction. The similarity is based on, for instance, the weather conditions during those most “similar” days. By way of particular example, the following equation may be used to predict the output by a photovoltaic array (PV) in hourly time-slots.

$${\hat{y}}_{t} = \frac{{\sum }_{i ∈ Nk ( {x}_{t} , D )}^{ } {y}_{i} / d ( {x}_{i} , {x}_{t} )}{{\sum }_{i ∈ Nk ( {x}_{t} , D )}^{ } 1 / d ( {x}_{i} , {x}_{t} )} \qquad Equation ( 1 )$$

In Equation (1), ŷₜ is the predicted output of the PV at hour t; yᵢ is the actual output of a neighbor i of the PV; x is a feature vector, such as, temperature, humidity, etc.; d is a distance metric function; and Nₖ(x,D) is the set of k nearest neighbors of x in D.

At block 304, a demand for resources in the facility 102 during the predetermined period of time is predicted, for instance, by the resource demand prediction module 208. The resource demand prediction module 208 may predict the demand for resources through use of historical resource demand information to determine patterns of resource usage and future demands, for instance, as collected by the resource demand monitor 106. Although there is relatively large variability in resource demands, resource demands for interactive workloads often exhibit clear short-term and long-term patterns. Various factors that may be employed to predict the demand for resources include calendar information, such as, weekends, holidays, etc., information on specials events, such as, payroll calculations at the end of the month, or other known periods of high activity, etc.

According to an example, the resource demand prediction module 208 first performs a periodicity analysis of the historical workload traces to determine the length of a pattern or a sequence of patterns that appear periodically. More particularly, for instance, a Fast Fourier Transform (FFT) is used to find the periodogram of the time-series data. From this, periods of the most prominent patterns or sequences of patterns are derived. For example, most interactive workloads exhibit prominent daily patterns. An auto-regressive model may then be created to capture both the long term and short term patterns according to the following model. More particularly, the following model estimates w(d,t), the demand at time t on day d, based on the demand of previous N days and previous M time points of the same day.

$$w ( d , t ) = {\sum }_{i = 1}^{N} {a}_{i} * w ( d - i , t ) + {\sum }_{j = 1}^{M} {b}_{i} * w ( d , t - j ) + c \qquad Equation ( 2 )$$

The parameters in Equation (2) may then be calibrated using the historical data. In Equation (2), a, b and c comprise coefficients.

In another example, the FFT computation is omitted for the resource demand prediction. Instead, the relevant variables in the historical data are identified by feature selection methods, such as regularization. In this example, a large number for prior days, hours and other related variables are considered. For instance, N and M in Equation (2) may be in the order of tens. In addition, an objective function used to minimize the sum of square errors is augmented with a regularization term related to the number/magnitude of the coefficients used in the above regression. One result of this operation is that irrelevant variables drop out as their coefficients go to zero. Examples of such regularization terms are similar to those used in Lasso, ridge-regression, or other similar methods. Using such methods the coefficients may, for example, be determined by solving the following equation:

$$( {a}_{i} , {b}_{i} ) = arg min {\sum }_{{training}_{data}}^{ } \{ \begin{matrix}w ( d , t ) - {\sum }_{i = 1}^{N} {a}_{i} * w ( d - i , t ) - \\ {\sum }_{j = 1}^{M} {b}_{i} * w ( d , t - j ) - c + \\ λ ( \sum \vert {a}_{i} \vert + \sum \vert {b}_{i} \vert )\end{matrix} \} \qquad Equation ( 3 )$$

The prediction of the demand for resources in the facility 102 may also include a prediction for the demand of resources by the dependent system components 116 in cooling the resource demand machines 112. In this example, the resource demand prediction module 208 may predict the demand for resources, such as, energy, cool airflow, water, chemicals, etc., by the dependent system components 116 through use of historical demand information to determine patterns of resource usage and future demands, for instance, as collected by the resource demand monitor 106. Thus, for instance, the resource demand prediction module 208 may predict the amount of outside air flow that may be delivered into the facility 102 at the predetermined period of time.

At block 306, a capacity schedule to meet a predefined operational goal is planned, for instance, by the capacity schedule planning module 210. According to an example, in planning the capacity schedule, the capacity schedule planning module 210 uses a plurality of inputs, including the predicted supply of resources available from the first resource supply 120 and the predicted demand for resources in the facility 102 during the predetermined period of time. The inputs may further include the predicted demand for resources by both the resource demand machines 112 to perform the workload and the dependent systems 116 to cool the machines 112, and a price of the resources available from the second resource supply 130. The predicted demand for resources in the facility 102 may also include the availability of outside cool airflow, which may reduce the demand for resources by the dependent system components 116.

Generally speaking, the capacity schedule planning is performed to develop a plan that substantially optimizes resource demand scheduling and capacity allocation scheduling to match the predicted resource supply available from the first resource supply 120. For instance, the capacity schedule plan is developed to substantially match resources available from the first resource supply 120 and the pricing of the resources supplied by the second resource supply 130 and the cooling supply, which may include chiller capacity and outside air cooling availability.

According to an example, the capacity schedule planning module 210 takes the predicted supply of resources available from the first resource supply 120, the predicted cooling supply and workload demand, and second resource price as inputs and generates an optimal scheduling for non-critical resource demand through demand shaping to meet a predefined operational goal. The operational goal may comprise at least one of that: (1) critical demand for resources is met; (2) at least a net-zero consumption of resources from the second resource supply 130 is achieved; (3) use of resources from the second resource supply 130 is minimized; (4) use of resources from the first resource supply 120 is maximized; and (5) operational costs are minimized. The non-critical demand may comprise demands by workloads that need not be performed at particular times or on demand. In this regard, non-critical demands may comprise demands by those workloads that may be performed as system resources are available. By way of particular example, the non-critical workloads comprise batch processing jobs for servers, such as, scientific applications, simulations, financial analysis, image processing, etc. Examples of critical workloads may comprise Internet services, interactive workloads, or other delay-intolerant workloads.

At block 308, the capacity schedule plan is executed, for instance, by the capacity schedule execution module 212. More particularly, the workload execution module 212 communicates instructions to the resource demand controller 110 pertaining to how the resources are to be consumed by the resource demand machines 112 during the predetermined period of time. By way of example, the capacity schedule execution module 212 communicates instructions to the resource demand controller 110 to cause the non-critical workloads to be performed according to the planned capacity schedule. In addition, according to an example, the capacity schedule execution module 212 communicates instructions to the dependent system controller 114 pertaining to how the dependent system components 116 are to be operated during the predetermined period of time. In another example, the dependent system controller 114 independently controls operations of the dependent system components 116 based upon operational conditions of the resource demand machines 112.

According to a particular example, the execution of the plan at block 308 includes the execution of a plurality of applications (workloads) on servers (resource demand machines 112). In this particular example, the functions of the resource demand controller 110 are split among three controllers that are focused on meeting service level agreements (SLAs). The three controllers include an application controller, a local node controller, and a workload management controller. The application controller is to adjust utilization targets for the components of the applications such that the service level objectives are met. In addition, the local node controller is to control a plurality of servers and to adjust the resource entitlements for each server according to the utilization targets. The local node controller also serves as an arbiter if resources are relatively scarce. The workload management controller maintains the workload allocation in the resource pool and migrates workloads between servers and powers-down or starts additional servers as required.

As discussed above, the workloads comprise different classes of workloads, for example, critical and non-critical workloads. According to an example, the demand created by the non-critical workloads may be shaped to meet the predefined operational goal. In this example, the workload management controller considers the available supply of resources from the first resource supply 120, for instance, available power, available cooling airflow, etc., and determines how much IT equipment (for instance, how many servers) may be supported according to the plan determined at block 306. The workload management controller also determines how much equipment is required to support the critical/interactive workloads, and how much additional equipment is required for the non-critical workloads under the constraints of the resource availability. In one regard, a facility operator may define policies such as the demands of critical workloads are always met while the demands of non-critical workloads are only met if sufficient resources, such as power, cooling, etc., are available. The workload management controller may use these policies to migrate the workloads (for instance, consolidating workloads in case the execution plan demands for less resource usage or balancing workloads if the plan allows more resource usage and the workloads would benefit), and power down or start additional IT equipment.

At block 310, a determination as to whether the planned capacity schedule meets the predefined operational goal is made, for instance, by the operational goal determination module 216. That is, for instance, the operational goal determination module 216 continuously monitors the execution of the plan and the actual availability of resources. In response to a determination that the planned capacity schedule meets the predetermined operational goal, according to an example, the plan is continued to be executed at block 308. However, in response to a determination that the planned capacity schedule does not meet the predetermined operational goal, blocks 302-308 are repeated to determine another plan for the capacity schedule.

According to an example, the determination as to whether the planned capacity schedule meets the predefined operational goal at block 310 includes determining whether the resource availability is substantially consistent with the predicted supply of resources available from the first resource supply 120 and determining whether the monitored resource utilization is substantially consistent with the predicted demand for resources.

According to an example, the predetermined period of time is static, for instance, every day for the execution of the next day. According to another example, the predetermined period of time is dynamic, for instance, a new plan is created if the current plan differs beyond a predetermined tolerance level from the actual supply of resources and demand for resources, if the current plan cannot be executed as planned, or if the planning period has ended. In addition, the method 300 may be repeated for the same time period or for different time periods.

At instances before, during, and after performance of the method 300, various data may be outputted, for instance, by the input/output module 204. Thus, for instance, the input/output module 204 may output an indication as to whether the capacity schedule planned at block 306 and executed at block 308 meets the predefined operational goal.

Some or all of the operations set forth in the method 300 may be contained as a utility, program, or subprogram, in any desired computer accessible medium. In addition, the method 300 may be embodied by computer programs, which may exist in a variety of forms both active and inactive. For example, they may exist as machine readable instructions, including source code, object code, executable code or other formats. Any of the above may be embodied on a non-transitory computer readable storage medium.

Examples of non-transitory computer readable storage media include conventional computer system RAM, ROM, EPROM, EEPROM, and magnetic or optical disks or tapes. It is therefore to be understood that any electronic device capable of executing the above-described functions may perform those functions enumerated above.

Turning now to FIG. 4, there is shown a schematic representation of a computing device 400, which may be employed to perform various functions of the facility manager module 202 depicted in FIG. 2, according to an example. The computing device 400 includes one or more processors 402, such as but not limited to a central processing unit; one or more display devices 404, such as but not limited to a monitor; one or more network interfaces 408, such as but not limited to a Local Area Network LAN, a wireless 802.11x LAN, a 3G mobile WAN or a WiMax WAN; and one or more computer-readable mediums 410. Each of these components is operatively coupled to one or more buses 412. For example, the bus 412 may be an EISA, a PCI, a USB, a FireWire, a NuBus, or a PDS.

The computer readable medium 410 may be any suitable medium that participates in providing instructions to the processor 402 for execution. For example, the computer readable medium 410 may be non-volatile media, such as memory. The computer-readable medium 410 may also store an operating system 414, such as but not limited to Mac OS, MS Windows, Unix, or Linux; network applications 416; and a facility managing application 418. The operating system 414 may be multi-user, multiprocessing, multitasking, multithreading, real-time and the like. The operating system 414 may also perform basic tasks such as but not limited to recognizing input from input devices, such as but not limited to a keyboard or a keypad; sending output to the display 404; keeping track of files and directories on medium 410; controlling peripheral devices, such as but not limited to disk drives, printers, image capture device; and managing traffic on the one or more buses 412. The network applications 416 include various components for establishing and maintaining network connections, such as but not limited to machine readable instructions for implementing communication protocols including TCP/IP, HTTP, Ethernet, USB, and FireWire.

The facility managing application 418 provides various components for managing a facility as discussed above with respect to the method 300 in FIG. 3. The facility managing application 418 may thus comprise the input/output module 204, the resource supply prediction module 206, the resource demand prediction module 208, the capacity planning module 210, the capacity schedule execution module 212, the monitoring module 214, and the operational goal determination module 216. In this regard, the facility managing application 418 may include modules for predicting a supply of resources available from a first resource supply for a predetermined period of time, predicting a demand for resources in the facility during the predetermined period of time, planning a capacity schedule to meet a predefined operational goal, wherein the plan of the capacity schedule includes as inputs, the predicted supply of resources available from the first resource supply and the predicted demand for resources in the facility during the predetermined period of time, and determining whether the planned capacity schedule meets the predefined operational goal.

In certain examples, some or all of the processes performed by the facility managing application 418 may be integrated into the operating system 414. In certain examples, the processes can be at least partially implemented in digital electronic circuitry, or in computer hardware, machine readable instructions (including firmware and software), or in any combination thereof, as also discussed above.

What has been described and illustrated herein are examples of the disclosure along with some variations. The terms, descriptions and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

What is claimed is:

1. A method for managing a facility that is to receive resources from a first resource supply, the method comprising:
(a) predicting a supply of resources available from the first resource supply for a predetermined period of time;
(b) predicting a demand for resources in the facility during the predetermined period of time;
(c) planning, by a processor, a capacity schedule for the facility to meet a predefined operational goal, wherein planning the capacity schedule uses as inputs, the predicted supply of resources available from the first resource supply and the predicted demand for resources in the facility during the predetermined period of time; and
(d) determining whether the planned capacity schedule meets the predefined operational goal.

2. The method according to claim 1, wherein the facility is to receive resources from a second resource supply, and wherein the first resource supply differs from the second resource supply in that at least one of:
the first resource supply comprises a renewable power supply and the second resource supply comprises a nonrenewable power supply;
the resource available from the first resource supply is relatively less expensive than a resource available from the second resource supply; and
the first resource supply is relatively more sustainable than the second resource supply.

3. The method according to claim 1, further comprising:
outputting at least one of instructions pertaining to the planned capacity schedule and an indication as to whether the planned capacity schedule meets the predefined operational goal.

4. The method according to claim 1, further comprising:
executing the planned capacity schedule during the predetermined period of time;
monitoring resource availability and resource utilization while the planned capacity schedule is being executed; and
wherein (d) further comprises,
determining whether the resource availability is substantially consistent with the predicted supply of resources available from the first resource supply; and
determining whether the monitored resource utilization is substantially consistent with the predicted demand for resources.

5. The method according to claim 4, further comprising:
in response to a determination that at least one of the resource availability and the monitored resource utilization is substantially inconsistent with the respective predicted supply of resources available from the first resource supply and the predicted demand for resources, repeating (a)-(d).

6. The method according to claim 1, wherein (a) further comprises predicting the supply of resources available from the first resource supply for the predetermined period of time through an analysis of historical information pertaining to the supply of resources from the first resource supply.

7. The method according to claim 1, wherein (b) further comprises predicting the demand for resources in the facility during the predetermined period of time through use of historical demand information to determine patterns of resource usage and future demands.

8. The method according to claim 1, wherein (b) further comprises predicting the demand for resources by both machines to perform the workload and cooling systems to cool the machines in the facility during the predetermined period of time.

9. The method according to claim 8, wherein planning the capacity schedule further uses as inputs, the predicted demand for resources by both the machines to perform the workload and the cooling systems to cool the machines, and a price of resources available from the second resource supply, wherein the workload comprises critical workload and non-critical workload, and wherein (c) further comprises planning the capacity schedule using the inputs that substantially optimizes a scheduling of the non-critical workload while meeting the predefined operational goal.

10. A facility manager that is to receive resources from a first resource supply, said facility manager comprising:
a memory storing at least one module comprising machine readable instructions to:
(a) predict a supply of resources available from the first resource supply for a predetermined period of time;
(b) predict a demand for resources in the facility during the predetermined period of time;
(c) plan a capacity schedule for the facility that meets a predefined operational goal, wherein the plan of the capacity schedule includes as inputs, the predicted supply of resources available from the first resource supply and the predicted demand for resources in the facility during the predetermined period of time;
(d) execute the capacity schedule during the predetermined period of time; and
(e) determine whether the planned capacity schedule meets the predefined operational goal; and
a processor to implement the at least one module.

11. The facility manager according to claim 10, wherein the at least one module further comprises machine-readable instructions to:
output at least one of instructions pertaining to the planned capacity schedule and an indication as to whether the planned capacity schedule meets the predefined operational goal.

12. The facility manager according to claim 10, wherein the at least one module further comprises machine readable instructions to:
monitor resource availability and resource utilization while the capacity schedule is being executed; and
wherein (e) further comprises,
determine whether the resource availability is substantially consistent with the predicted supply of resources available from the first resource supply; and
determine whether the monitored resource utilization is substantially consistent with the predicted demand for resources.

13. The facility manager according to claim 10, wherein the at least one module further comprises machine readable instructions to:
in response to a determination that at least one of the resource availability and the monitored resource utilization is substantially inconsistent with the respective predicted supply of resources available from the first resource supply and the predicted demand for resources, repeating (a)-(e).

14. The facility manager according to claim 10, wherein the at least one module further comprises machine readable instructions to:
predict the demand for resources by both machines to perform the workload and cooling systems to cool the machines in the facility during the predetermined period of time; and
wherein the plan of the capacity schedule further includes as inputs, the predicted demand for resources by both the machines to perform the workload and the cooling systems to cool the machines, and a price of resources available from the second resource supply, wherein the workload comprises critical workload and non-critical workload, and wherein (c) further comprises using the inputs to plan the capacity schedule that substantially optimizes a scheduling of the non-critical workload while meeting the predefined operational goal.

15. A non-transitory computer readable storage medium on which is embedded at least one computer program, said at least one computer program implementing a method for managing a facility that is to receive resources from a first resource supply and a second resource supply, wherein the first resource supply differs from the second resource supply, said at least one computer program comprising computer readable code to:
predict a supply of resources available from the first resource supply for a predetermined period of time;
predict a demand for resources in the facility during the predetermined period of time;
plan a capacity schedule for the facility that meets a predefined operational goal, wherein the plan of the capacity schedule includes as inputs, the predicted supply of resources available from the first resource supply, the predicted demand for resources in the facility during the predetermined period of time, and a price of resources available from the second resource supply;
execute the capacity schedule during the predetermined period of time; and
determine whether the planned capacity schedule meets the predefined operational goal.
